(19) United States
(12) Patent Application Publication
(10) Pub. No.: US 2023/0289066 A1
(43) Pub. Date: Sep. 14, 2023

(54) RECONFIGURABLE MULTIBIT ANALOG IN-MEMORY COMPUTING WITH COMPACT COMPUTATION

(71) Applicant: Intel Corporation, Santa Clara, CA (US)

(72) Inventors: Renzhi Liu, Portland, OR (US); Hechen Wang, Portland, OR (US); Richard Dorrance, Hillsboro, OR (US); Deepak Dasalukunte, Beaverton, OR (US); Brent Carlton, Portland, OR (US)

(21) Appl. No.: 18/187,950

(22) Filed: Mar. 22, 2023

(51) Int. Cl. G06F 3/06; G06N 3/0464; G06F 7/544

(52) U.S. Cl. CPC G06F 3/0613; G06N 3/0464; G06F 3/0659; G06F 3/0673; G06F 7/5443

(57) ABSTRACT

Systems, apparatuses and methods may provide for technology that includes a memory array to store multibit weight data and a capacitor ladder network to conduct multiply-accumulate (MAC) operations on first analog signals and multibit weight data, the capacitor ladder network further to output second analog signals based on the MAC operations, wherein the capacitor ladder network is external to the memory array. In one example, the capacitor ladder network includes a plurality of switches and the logic includes a controller to selectively activate the plurality of switches based on a data format of the multibit weight data.

### TECHNICAL FIELD

Embodiments generally relate to artificial intelligence (AI) computing. More particularly, embodiments relate to reconfigurable multibit analog in-memory computing with compact computation for AI applications.

### BACKGROUND OF THE DISCLOSURE

A neural network (NN) can be represented as a structure that is a graph of several neuron layers flowing from one layer to the next. The outputs of one layer of neurons can be based on calculations, and are the inputs of the next layer. To perform these calculations, a variety of matrix-vector, matrix-matrix, and tensor operations may be required, which are themselves comprised of many multiply-accumulate (MAC) operations. Indeed, there are so many of these MAC operations in a neural network, that such operations may dominate other types of computations (e.g., activation and pooling functions). The neural network operation may be enhanced by reducing data fetches from long term storage and distal memories separated from the MAC unit.

Compute-in-memory (CiM) static random-access memory (SRAM) architectures (e.g., merged memory and MAC units) may deliver increased efficiency to convolutional neural network (CNN) models as compared to near-memory computing architectures due to reduced latencies associated with data movement. A notable trend in CiM processor architectures may be to use analog mixed-signal (AMS) hardware when performing MAC operations (e.g., multiplying analog input activations by digital weights and accumulating the result) in a CNN model. In such a case, a C-2C capacitor ladder network may be integrated (e.g., embedded, incorporated) within the SRAM to perform the MAC operations. Integrating the C-2C capacitor ladder network within the SRAM may increase circuit area, and in turn reduce memory density. Additionally, conventional C-2C capacitor ladder network solutions are typically limited to a fixed data format for the weights, which may have a negative impact on flexibility and/or performance.

### BRIEF DESCRIPTION OF THE DRAWINGS

The various advantages of the embodiments will become apparent to one skilled in the art by reading the following specification and appended claims, and by referencing the following drawings, in which:

FIG. 1 is a comparative schematic diagram of an example of a conventional capacitor ladder network that is integrated within a memory array and an enhanced capacitor ladder network that is external to a memory array according to an embodiment;

FIG. 2 is a set of schematic diagrams indicating equivalent circuits according to an embodiment;

FIG. 3 is a schematic diagram of an example of an 8-bit C-2C ladder-based combination for an 8-bit weight and input activation multiply-accumulate (MAC) operation according to an embodiment;

FIG. 4 is a comparative plan view of a conventional static random access memory (SRAM) cluster and an enhanced SRAM cluster according to an embodiment;

FIG. 5 is a schematic diagram of an example of a reconfigurable out-of-SRAM capacitance ladder based multibit combination for analog MAC operations according to an embodiment;

FIG. 6A is a schematic diagram of an example of a capacitance ladder configuration for an 8-bit integer (INT8) weight data format according to an embodiment;

FIG. 6B is a schematic diagram of an example of a capacitance ladder configuration for a 4-bit integer (INT4) weight data format according to an embodiment;

FIG. 7A is a schematic diagram of an example of an 8:1 analog multiplexer (MUX) for output activation (OA) lines and multiplexed OA (mOA) outputs according to an embodiment;

FIG. 7B is a schematic diagram of an example of an 8:2 analog MUX for OA lines and mOA outputs according to an embodiment;

FIG. 8 is a schematic diagram of an example of a capacitance ladder configuration with switch parasitic capacitance according to an embodiment;

FIGS. 9 and 10 are flowcharts examples of methods of operating a performance-enhanced computing system according to embodiments;

FIG. 11 is a block diagram of an example of a performance-enhanced computing system according to an embodiment; and

FIG. 12 is an illustration of an example of a semiconductor package apparatus according to an embodiment.

### DETAILED DESCRIPTION

Compute-in-Memory (CiM), one of the computation methods that is not based on classical von Neumann architecture, is a promising candidate for convolutional neural network (CNN) and deep neural network (DNN) applications. The development of CiM architectures, however, is more difficult to realize in purely digital systems, since the conventional multiply-accumulate (MAC) operation units are too large to fit into high-density Manhattan style memory arrays.

Currently, most of the practical CiM works are developed with static random access memory (SRAM) technologies. Among them, the solutions that primarily use digital computation can only utilize a small fraction of the entire SRAM memory array for simultaneous computation with a multibit data format. This limitation is because the digital computational circuit size for multibit data increases quadratically with the number of bits, whereas the memory circuit size within SRAM array increases linearly. Accordingly, there is a substantial mismatch between unit computational circuit size and unit memory circuit size for multibit implementations. As a result, only a small number of computational circuit units can be implemented for all-digital solutions, which causes a significant bottleneck in the overall throughput of in-memory computing.

To achieve efficient and high-throughput multibit in-memory computing, a C-2C-ladder-based analog MAC unit can be used for SRAM-based multibit CiM schemes. Additionally, an improved SRAM design with multiplexing capability may be used to achieve better supporting weight stationary machine language (ML) operations. Moreover, an analog in-memory computing macro may be used that can be built from standard SRAM macros.

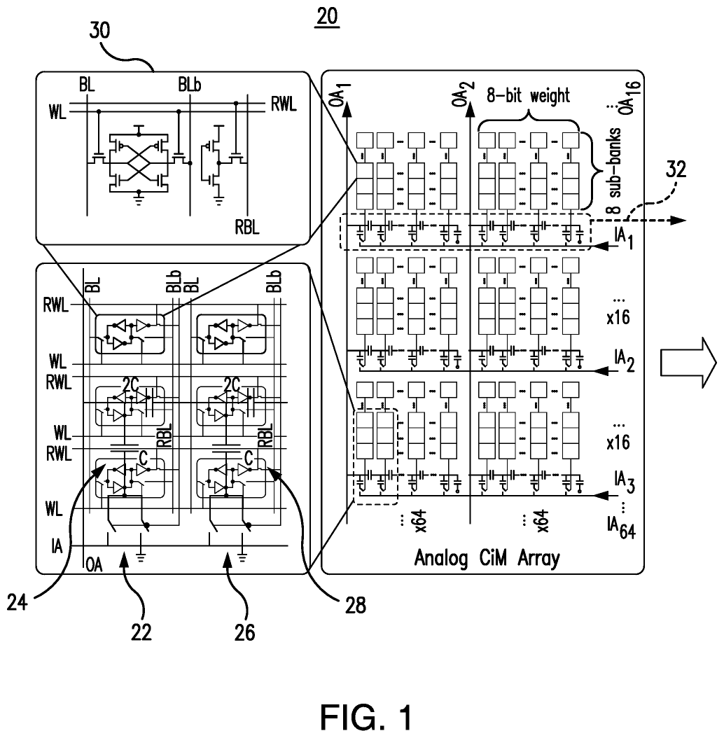

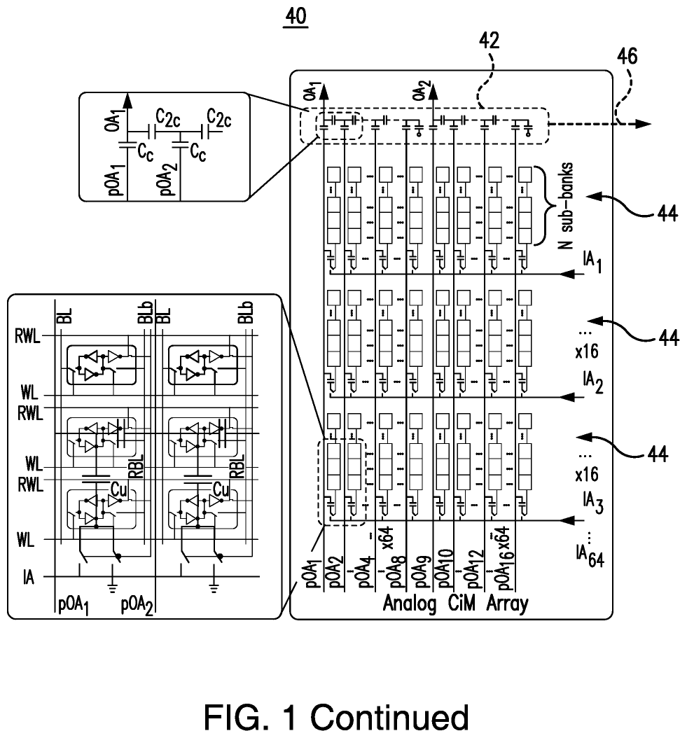

Turning now to FIG. 1, a conventional architecture 20 is shown in which a first 1-bit-8-bank SRAM cluster 22 includes a first capacitor ladder 24 (e.g., containing a parallel one unit capacitance C and a series two unit capacitance 2C), a second 1-bit bank SRAM cluster 26 includes a second capacitor ladder 28 (e.g., containing a parallel one unit capacitance C and a series two unit capacitance 2C), and so forth. In general, digital weight data stored in nine-transistor (9T) SRAM cells 30 is provided to the capacitor ladders 24, 28 via read bit lines (RBLs) and a plurality of switches. The output of the capacitor ladders 24, 28 is an in-SRAM C-2C multibit combination 32. Because the capacitor ladders 24, 28 reside within SRAM cluster 22, 26, respectively, a relatively high circuit area overhead and reduced memory density may result.

By contrast, an enhanced architecture 40 includes a capacitor ladder network 42 that is external to a memory array 44 (e.g., SRAM cluster) and generates an out-of-SRAM C-2C multibit combination 46, which substantially reduces circuit area overhead and increases memory density. More particularly, moving the capacitor ladder network 42 for multi-bit combination out of the memory array 44 enables each SRAM cluster to perform 1-bit weight and input activation (IA) multiplication with only a one unit capacitor Cᵤ, rather than a one unit (C) capacitor plus a two unit (2C) capacitor as in the conventional architecture 20. Such an approach significantly reduces the capacitor circuit area overhead while increasing memory cell density for weight storage.

For example, there are several differences between the enhanced architecture 40 and the conventional architecture 20. First, within each 1-bit-8-bank SRAM cluster 22, 26 in the conventional architecture 20 (e.g., that contains 1-bit weight data with N sub-banks for weight data multiplexing), the enhanced architecture 40 only has one unit capacitor Cᵤ, rather than one C and one 2C. The compactness from this single Cᵤ capacitor alone provides the out-of-SRAM multibit combination scheme the ability to reduce the analog MAC circuit overhead (i.e., the capacitors in the SRAM cluster). As result, more SRAM cells can fit within each SRAM cluster of the same size by providing even more sub-banks for multiplexing or reduce the size of the SRAM cluster if the number of sub-banks is kept the same. In either case, the weight storage density within the SRAM array can be increased, while in the latter case, the MAC computation unit density is also increased (e.g., since more MAC units can fit within an SRAM array, as the SRAM cluster size is reduced).

Another difference is that the partial product of 1-bit weight and input activation (IA) within each SRAM cluster connects to a partial output activation (pOA) line for summation and averaging, achieving MAC operation. For comparison, in the conventional architecture 20, there may be no such pOA line for summation. Instead, the multibit combination of 1-bit weight and IA multiplication product is carried out locally between the neighboring SRAM clusters 22, 26 and only the SRAM cluster 22, 26 corresponding to the most significant bit (MSB) connects to an output activation (OA) line.

Yet another difference is that each pOA line is to be connected through a capacitance ladder network 42 outside the memory array 44 for multi-bit combination, which results in an OA line at the MSB output of the capacitance ladder that is corresponding to the multibit multi-dimensional (64-dimensional/64D) MAC computation. The enhanced architecture 40 has only one C-2C ladder for generating the MAC result on the OA line, whereas in the conventional architecture 20, the number of C-2C ladders involved is the same as the number of summations within the MAC operation (e.g., sixty-four).

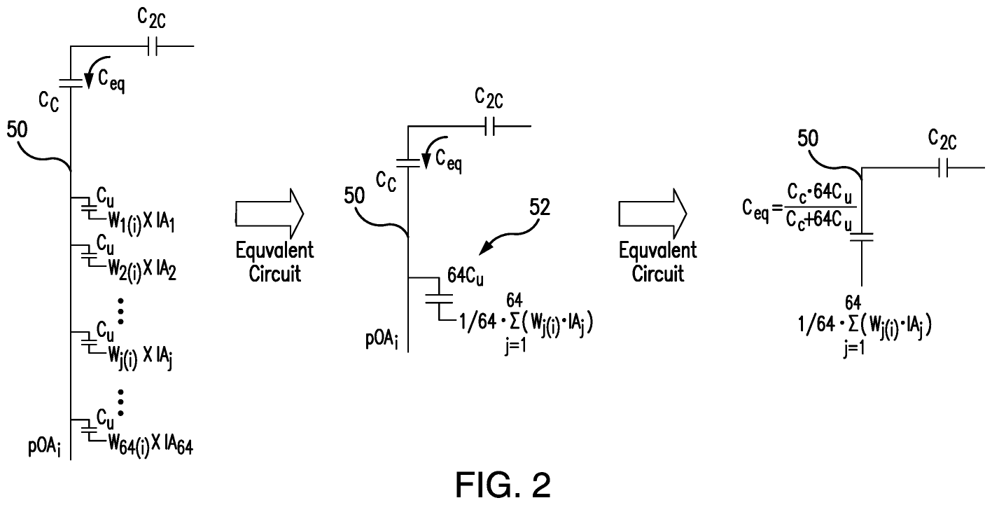

FIG. 2 shows the equivalent circuits along one pOA line 50. Using the same MAC dimension of sixty-four, sixty-four Cᵤ capacitors would be connected to each pOA line 50. Assuming the sixty-four 1-bit weights under computation is W₁₍ᵢ₎, . . . , W₆₄₍ᵢ₎, and sixty-four IA inputs are IA₁, . . . , IA₆₄, the result is W₁₍ᵢ₎×IA₁, . . . , W₆₄₍ᵢ₎×IA₆₄ at the bottom plates of those sixty-four Cᵤ capacitors, which is equivalent to having a lumped single 64Cᵤ capacitor 52 connected to the pOA line with a value of

$$\frac{1}{64} {Σ}_{j = 1}^{64} ( {W}_{j ( i )} \times {IA}_{j} )$$

at the bottom plate. Thus, a 64-D MAC operation has been achieved for sixty-four sets of 1-bit weights and IA inputs. It can be further assumed that the unit capacitors within the C-2C ladder are C_{C} and C_{2C} and the equivalent capacitance C_{eq} including C_{C} and 64Cᵤ is

$$\frac{{C}_{C} \cdot 64 {C}_{u}}{{C}_{C} + 64 {C}_{u}} .$$

In order to maintain the C-2C ratio for binary multi-bit combination, the following relationship can be enforced:

$${C}_{2 C} = 2 {C}_{e q} = 2 \frac{{C}_{C} \cdot 64 {C}_{u}}{{C}_{C} + 64 {C}_{u}} \qquad Eq . 1$$

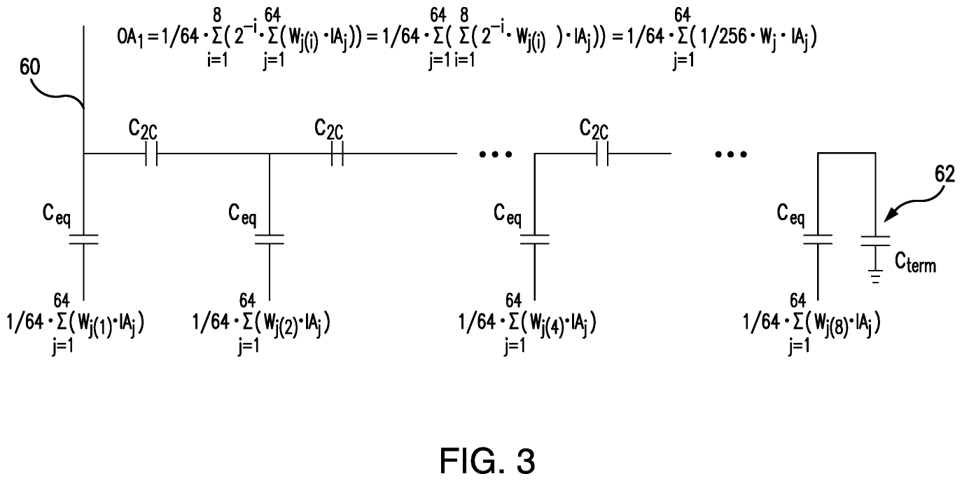

FIG. 3 shows one example of an 8-bit C-2C-ladder-based combination. The illustrated example has sixty-four weights of W₁, . . . , Wⱼ, . . . , W₆₄ in decimal format, where each Wⱼ can be written in 8-bit binary format as (Wⱼ₍₁₎, Wⱼ₍₂₎ . . . Wⱼ₍ᵢ₎ . . . Wⱼ₍₈₎)₂, and Wⱼ₍₁₎ is the MSB and Wⱼ₍₈₎ is the least significant bit (LSB). The example shown in FIG. 2 is then essentially the MAC operation for the i^{th} bit of these sixty-four weights and the sixty-four IA inputs. In FIG. 3, eight 64-D MAC results of 1-bit weight and IA are combined through an 8-bit C-2C ladder into a single OA line output 60. For the LSB bit within the 8-bit C-2C ladder, a termination capacitor 62 (Cₜₑᵣₘ) is used to terminate the C-2C ladder. For ideal C-2C weighting, the following expression is maintained,

Cₜₑᵣₘ=C_{2C}−C_{eq}=C_{eq} Eq. 2

The value at the OA line output 60 becomes

$$O A = \frac{1}{64} {\sum }_{i = 1}^{8} ( {2}^{- i} {\sum }_{j = 1}^{64} ( {W}_{j ( i )} \cdot {IA}_{j} ) ) = \frac{1}{64} {\sum }_{j = 1}^{64} ( \frac{1}{256} \cdot {W}_{j} \cdot {IA}_{j} ) \qquad Eq . 3$$

Thus, a 64-D MAC operation has been achieved for 8-bit weights and IA inputs using an out-of-SRAM C-2C-ladder-based multi-bit combination scheme with a fixed weight data format.

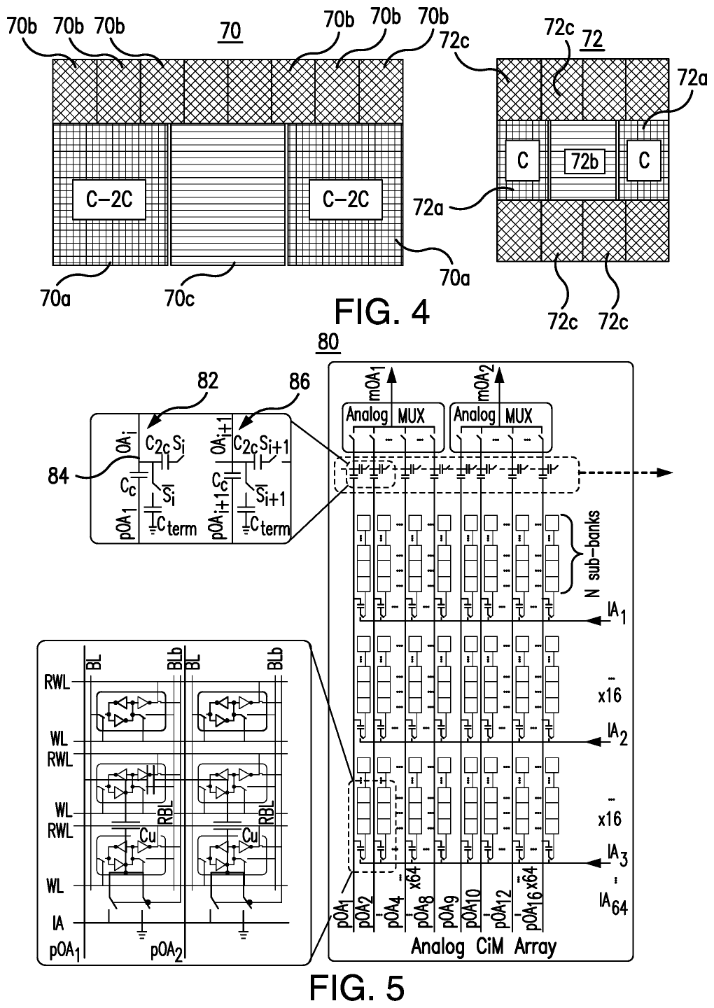

FIG. 4 shows an illustration of an example SRAM cluster 70 (70a-70c) of 1-bit-8-bank using an in-SRAM C-2C ladder 70a (e.g., including passive metal-oxide-metal/MOM capacitors) within a 9T SRAM cell 70b and control logic 70c (e.g., controller). By contrast, an enhanced SRAM cluster 72 (72a-72c) uses an out-of-SRAM multibit combination scheme that includes a single capacitor C 72a (e.g., including passive MOM capacitors) within a 9T SRAM cell 72c and control logic 72b (e.g., controller), while still supporting 1-bit weight with 8 banks. Due to the significant reduction on the capacitor sizes within the enhanced SRAM cluster 72, the SRAM cluster size can be effectively reduced by one half. Accordingly, 2×SRAM memory storage density, as well as 2×MAC computation unit density can be achieved. The increased computation unit density would directly translate to a much higher area efficiency performance metric for MAC implementation.

The technology described herein is also the first analog CiM solution with uniformed MAC unit design as well as a uniformed multibit recombination structure that resides outside the SRAM array. Accordingly, the technology described herein is more scalable and reconfigurable. Thus, embodiments deliver significant computation density improvement while keeping the uniformity of the structures for offering both scalability and reconfigurability in CiM array.

Reconfigurable Out-of-SRAM C-2C-Ladder-Based Multi-Bit Combination for Analog MAC

Additionally, the conventional architecture 20 (FIG. 1) has a fixed data format for the weights that are stored within the CiM macro. Such an approach is used because the C-2C-based multi-bit combination is performed for each weight and input activation multiplication product within the SRAM array and, due to circuit size constraints, the combination is hard-wired without any reconfigurability. Since the data format of the weights is tightly coupled with the C-2C ladder structure, the weight data format is fixed once a particular C-2C ladder structure is chosen. For example, the illustrated conventional architecture 20 (FIG. 1) has a data format of INT8. Although the format might be changed to INT4, or even a binary format, the data format is a design choice and cannot be changed natively once the CiM chip is manufactured. In addition to the basic scheme as proposed above, this section expands the scheme with reconfigurability for the data format of the weights (e.g., as stored in an SRAM array).

More particularly, placing the capacitor ladder network external to the memory array provides the ability to selectively activate a plurality of switches (not shown) based on the data format of the multibit weight data (e.g., after manufacture) because the circuit overhead for providing reconfigurability may now also reside outside the memory array (e.g., avoiding any negative impact on weight storage density). Indeed, different weight data formats may be used during inference when switching between neural network layers.

FIG. 5 shows a reconfigurable out-of-SRAM multi-bit combination architecture 80. As compared to the enhanced architecture 40 (FIG. 1), there are several differences as follows:

First, a unit C-2C cell 82 that is associated with the i^{th} pOA line (pOAᵢ) now has a termination capacitor Cₜₑᵣₘ and a pair of switches controlled by complementary signals of Sᵢ and S̅ᵢ̅ in addition to the C_{C} and C_{2C} capacitors. The unit C-2C cell 82 also has an output line 84 as OAᵢ. When Sᵢ is high and S̅ᵢ̅ is low, the unit C-2C cell 82 is connected to a neighboring C-2C cell 86 (e.g., corresponding to OAᵢ₊₁) for continuing the binary combination along the ladder while its respective Cₜₑᵣₘ is deactivated. Otherwise, the C-2C cell 82 disconnects from the neighboring C-2C cell 86 and becomes the LSB unit of one C-2C ladder with its respective termination capacitor Cₜₑᵣₘ activated. By adding the illustrated switch pairs and termination capacitors in each C-2C cell 82, 86, the flexibility is obtained to make any unit C-2C cell 82, 86 become the LSB unit of a C-2C ladder. Accordingly, the C-2C ladder can be configured to support various data formats of the weights.

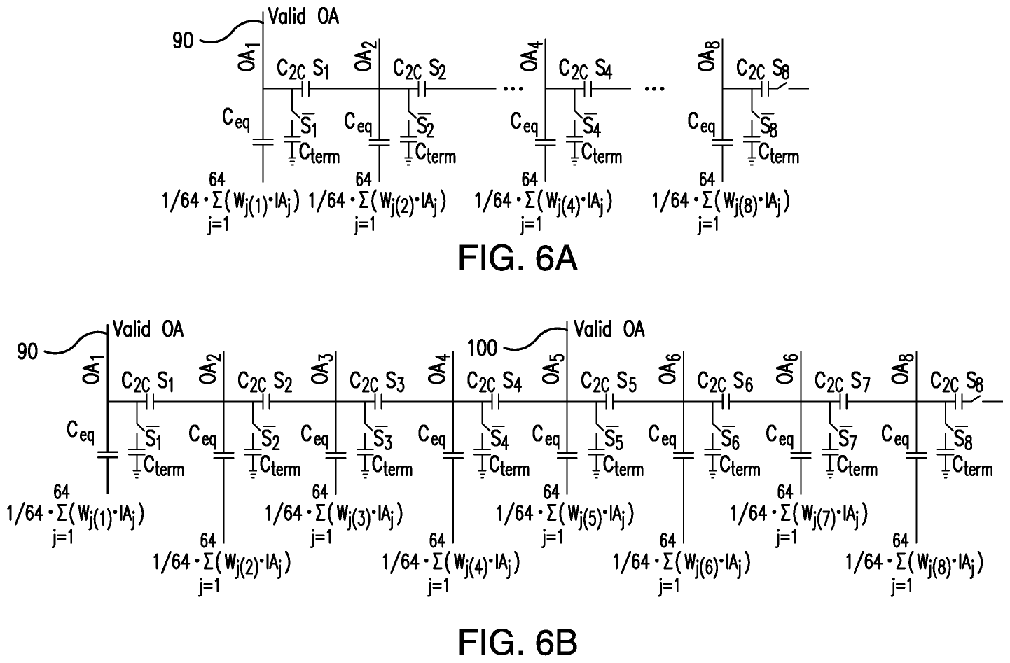

FIGS. 6A and 6B show two examples of C-2C ladder configurations to support INT8 and INT4 weight data formats, respectively. In FIG. 6A, switches S₁-S₇ are turned on, and switch S₈ is turned off. In this scenario, the resulting configuration is the same as shown in FIG. 3, and only OA₁ 90, which is the result of a 64-D MAC operation for 8-bit weights and IA inputs, is valid for the next stage. In FIG. 6B, switches S₁-S₃ and S₅-S₇ are turned on, while both switches S₄ and S₈ are turned off. By doing so, one set of 8-bit weight data is divided into two sets of 4-bit weight data, and both OA₁ 90 and OA₅ 100 are valid for the next stage, while each of them represents 64-D MAC operation result for 4-bit weights and IA inputs. In addition to INT8 and INT4, the C-2C ladder can be further broken down to support smaller data formats, such as 2-bit integer (INT2) and binary, or increased to larger data formats, such as 16-bit integer (INT16) by concatenating sixteen units of C-2C cells for combination. Also theoretically, the weight data stored within the SRAM array does not need to use one single data format. For example, eight units of C-2C cells can also be broken down to one set of 6-bit and one set of 2-bit for supporting INT6 and INT2 data formats, respectively, for two sets of weights in one configuration.

Embodiments provide for an analog MUX for multiplexing multiple OA lines to muxed OA (mOA) lines, such that the analog value on each mOA line can be digitized by a subsequent analog-to-digital data converter (ADC). The following discussion provides examples of the analog MUX to associate OA lines with mOA lines.

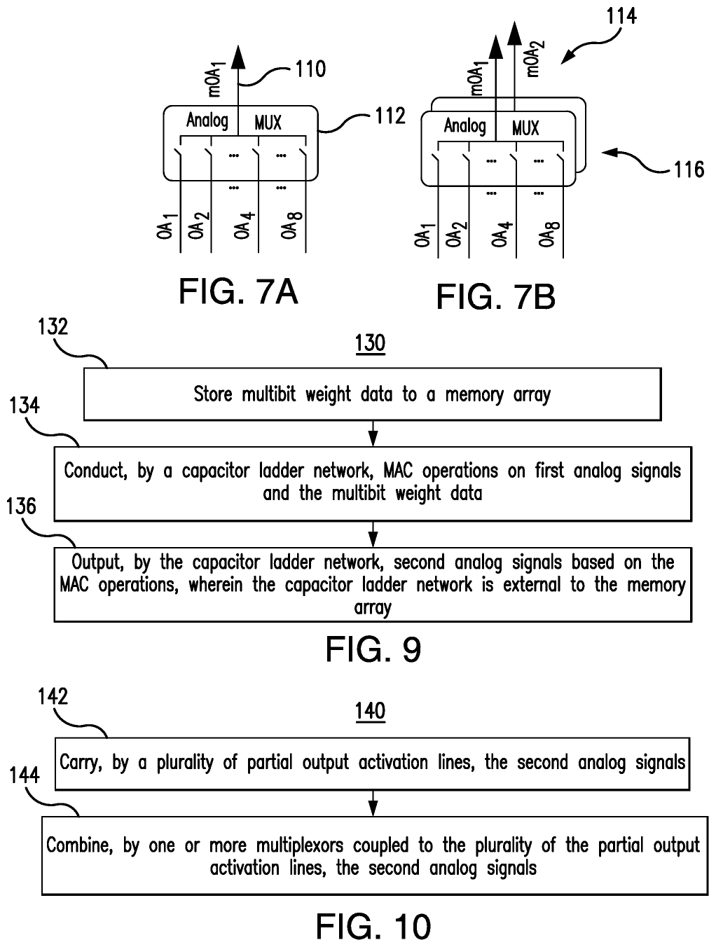

FIG. 7A demonstrates that eight OA lines can be multiplexed into one mOA output 110 by an analog MUX 112, with the anticipation of only one ADC being available for every eight OA lines (e.g., improving storage density). By contrast, FIG. 7B demonstrates that eight OA lines can be multiplexed into two mOA lines 114 by a plurality of analog MUXes 116, with the assumption of two ADCs being available (e.g., improving computational throughput and/or storage density). In an embodiment, not all OA lines need to be multiplexed. As shown in FIGS. 6A and 6B, for INT8 weight data format, only OA₁ is valid, while for INT4, only OA₁ and OA₅ are valid. In one example, the analog MUXes 112, 116 only multiplex those valid OA lines (e.g., given a specific weight data format) to mOA lines 110, 114 in a time-division multiplexing manner.

The added reconfigurability on various data formats is made practical by moving the C-2C ladder out of the SRAM array and reducing the number of C-2C ladders to only one for each MAC operation. With the C-2C ladder moving out of the SRAM array and a number of C-2C ladders being consolidated, the reconfigurability can be added rather efficiently with minimum circuit overhead since the reconfigurability is now only used for the one out-of-SRAM C-2C ladder that covers an entire 64-D MAC operation.

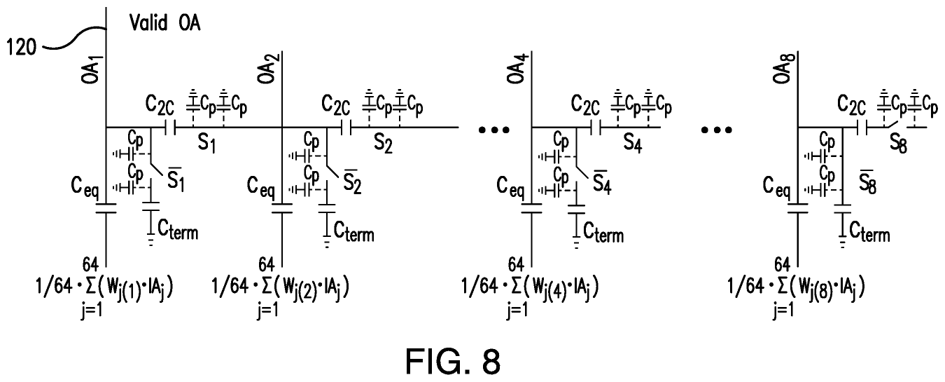

Turning now to FIG. 8, adding reconfigurability for multiple data formats support may introduce concerns for parasitic, noise and mismatch, since more circuits, specifically switch circuits are being added. In the illustrated example, parasitic capacitance is shown for an INT8 data format ladder configuration and INT8 weight data format. It can be assumed that there is a parasitic capacitance of Cₚ on each side of the switch. Accordingly, the 1C capacitor in the C-2C ladder, which was formerly only C_{eq}, may now be C_{eq}+3×Cₚ (2×Cₚ from an ON switch and another 1×Cₚ from an OFF switch). The capacitor relationship for maintaining binary multi-bit combination through the C-2C ladder as shown in Eq. 1 now becomes:

$${C}_{2 C} = 2 ( {C}_{e q} + 3 {C}_{p} ) = 2 ( \frac{{C}_{C} \cdot 64 {C}_{u}}{{C}_{C} + 64 {C}_{u}} + 3 {C}_{p} ) \qquad Eq . 4$$

Likewise, the termination capacitor, Cₜₑᵣₘ, may now be:

Cₜₑᵣₘ=C_{2C}−C_{eq}−4Cₚ=C_{eq}+2Cₚ Eq. 5

Due to the charge sharing from parasitic capacitance, the OA line values would also have another scaling factor

$$\frac{{C}_{e q}}{{C}_{e q} + 3 {C}_{p}} ,$$

and the resulting UA line voltage is shown below:

$$O A = \frac{1}{64} ( \frac{{C}_{e q}}{{C}_{e q} + 3 {C}_{p}} ) {\sum }_{i = 1}^{8} ( {2}^{- i} {\sum }_{j = 1}^{64} ( {W}_{j ( i )} \cdot {IA}_{j} ) ) = \frac{1}{64} ( \frac{{C}_{e q}}{{C}_{e q} + 3 {C}_{p}} ) {\sum }_{j = 1}^{64} ( \frac{1}{256} \cdot {W}_{j} \cdot {IA}_{j} ) \qquad Eq . 6$$

Although the OA line voltage is attenuated as compared to Eq. 3, this attenuation is a linear operation and the effect of this scaling can be digitally reversed once the OA line 120 is digitized through an ADC (not shown).

Similarly, this reconfigurability may have a very minor penalty with respect to noise and mismatch. For noise, the capacitor itself does not have noise. Rather, the sampling process through a resistor adds the so-called KT/C noise (e.g., Johnson-Nyquist noise, which is a function of the Boltzmann constant (K), temperature (T) and capacitance (C)) to the voltage value stored on the capacitor, and the KT/C noise value has a square root relationship to capacitor size C. Accordingly, the added reconfigurability which incurred additional parasitic capacitance, would only decrease the absolute KT/C noise value. It can be shown that the overall KT/C noise has a scaling factor of

$$\sqrt{\frac{{C}_{e q}}{{C}_{e q} + 3 {C}_{p}}}$$

after accounting for the parasitic capacitance. Also as shown above, the OA values, which is the signal here, has a linear scaling factor of

$$\frac{{C}_{e q}}{{C}_{e q} + 3 {C}_{p}} .$$

As a result, the signal-to-noise (SNR) ratio is then scaled by

$$\sqrt{\frac{{C}_{e q}}{{C}_{e q} + 3 {C}_{p}}} ,$$

which is a very minor negative impact on SNR. For example, if 3Cₚ adds up to 20% of the C_{eq}, then the SNR on OA lines would only degrade by about 10% or 0.8 dB, which translates to 0.13 bits. As for mismatch concerns, the overall capacitance including the parasitic capacitance may be most relevant. Therefore, the overall mismatch is not degraded with added reconfigurability.

FIG. 9 shows a method 130 of operating a performance-enhanced computing system. The method 130 may generally be implemented in a computing architecture such as, for example, the enhanced architecture 40 (FIG. 1), already discussed. More particularly, the method 1730 may be implemented as hardware in configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Illustrated processing block 132 provides for storing multibit weight data to a memory array. In one example, the memory array includes an SRAM. Block 134 conducts, by a capacitor ladder network, MAC operations on first analog (e.g., input activation) signals and the multibit weight data. Additionally, block 136 outputs, by the capacitor ladder network, second analog (e.g., output activation) signals based on the MAC operations, wherein the capacitor ladder network is external to the memory array. The capacitor ladder network may include a C-2C capacitor ladder network.

In an embodiment, the capacitor ladder network includes a plurality of switches and block 134 includes selectively activating, by a controller, the plurality of switches based on a data format of the multibit weight data. In such a case, the plurality of switches may include a plurality of switch pairs (e.g., S₁ and S̅₁̅), wherein each switch pair corresponds to one of the second analog signals. Moreover, the data format may include an INT16 format, INT8 format, an INT4 format, a binary format, etc., or any combination thereof. The illustrated method 130 therefore enhances performance at least to the extent that positioning the capacitor ladder network external to the memory array increases throughput, improves efficiency and/or reduces MAC computation circuit overhead. Moreover, selectively activating the plurality of switches based on the data format of the multibit weight data further enhances performance through improved reconfigurability.

FIG. 10 shows another method 140 of operating a performance-enhanced computing system. The method 140 may generally be implemented in a computing architecture such as, for example, the enhanced architecture 40 (FIG. 1), already discussed, and in conjunction with the method 130 (FIG. 9), already discussed. More particularly, the method 140 may be implemented as hardware in configurable logic, fixed-functionality logic, or any combination thereof.

Illustrated processing block 142 carries, by a plurality of output activation (OA) lines, the second analog signals. Block 144 combines, by one or more multiplexers coupled to the plurality of OA lines, the second analog signals. In an embodiment, block 144 combines only valid OA lines given a specific weight data format to mOA lines in a time-division multiplexing manner. The method 140 therefore further enhances performance at least to the extent that combining the second analog signals as shown improves computational throughput and/or storage density.

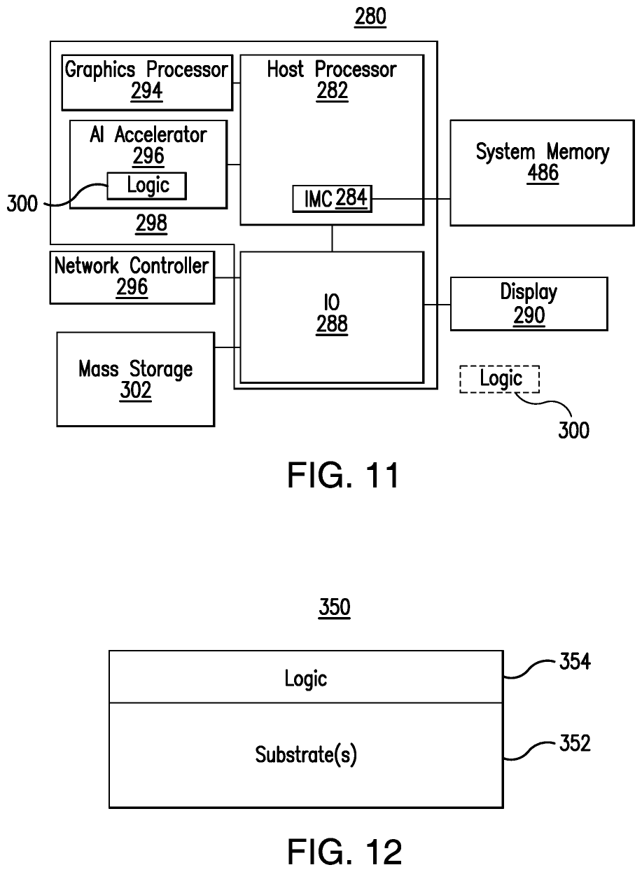

Turning now to FIG. 11, a performance-enhanced computing system 280 is shown. The system 280 may generally be part of an electronic device/platform having computing functionality (e.g., personal digital assistant/PDA, notebook computer, tablet computer, convertible tablet, edge networking device, server, cloud computing infrastructure), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the system 280 includes a host processor 282 (e.g., central processing unit/CPU) having an integrated memory controller (IMC) 284 that is coupled to a system memory 286 (e.g., dual inline memory module/DIMM). In an embodiment, an TO (input/output) module 288 is coupled to the host processor 282. The illustrated TO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the TO module 288, a graphics processor 294, and an AI accelerator 296 into a system on chip (SoC) 298.

In an embodiment, the AI accelerator 296 includes the enhanced architecture 40 (FIG. 1), already discussed. Thus, the AI accelerator 296 may include logic 300 (e.g., coupled to one or more substrates) that performs one or more aspects of the method 130 (FIG. 9) and/or the method 140 (FIG. 10), already discussed. The logic 300 may therefore include a memory array (e.g., SRAM) to store multibit weight data and a capacitor ladder network (e.g., C-2C capacitor ladder network) to conduct MAC operations on first analog signals and the multibit weight data, the capacitor ladder network to further output second analog signals based on the MAC operations, wherein the capacitor ladder network is external to the memory array. The computing system 280 is therefore considered performance-enhanced at least to the extent that positioning the capacitor ladder network external to the memory array increases throughput, improves efficiency and/or reduces MAC computation circuit overhead. Although the logic 300 is shown within the AI accelerator 296, the logic 300 may reside elsewhere in the computing system 280.

FIG. 12 shows a semiconductor apparatus 350 (e.g., chip, die, package). The illustrated apparatus 350 includes one or more substrates 352 (e.g., silicon, sapphire, gallium arsenide) and logic 354 (e.g., circuitry, transistor array and/or other integrated circuit/IC components) coupled to the substrate(s) 352. The logic 354 may be readily substituted for the logic 300 (FIG. 11), already discussed. In an embodiment, the logic 354 implements one or more aspects of the method 130 (FIG. 9) and/or the method 140 (FIG. 10), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

### Additional Notes and Examples

Example 1 includes a performance-enhanced computing system comprising a network controller and a processor coupled to the network controller, the processor including logic coupled to one or more substrates, wherein the logic includes a memory array to store multibit weight data and a capacitor ladder network to conduct multiply-accumulate (MAC) operations on first analog signals and the multibit weight data, the capacitor ladder network further to output second analog signals based on the MAC operations, wherein the capacitor ladder network is external to the memory array.

Example 2 includes the computing system of Example 1, wherein the capacitor ladder network includes a plurality of switches and the logic includes a controller to selectively activate the plurality of switches based on a data format of the multibit weight data.

Example 3 includes the computing system of Example 2, wherein the plurality of switches includes a plurality of switch pairs, and wherein each switch pair corresponds to one of the second analog signals.

Example 4 includes the computing system of Example 2, wherein the data format includes one of an eight-bit integer format or a four-bit integer format.

Example 5 includes the computing system of Example 1, wherein the capacitor ladder network includes a plurality of partial output activation lines to carry the second analog signals, and one or more multiplexers coupled to the plurality of partial output activation lines, the one or more multiplexers to combine the second analog signals.

Example 6 includes the computing system of any one of Examples 1 to 5, wherein the memory array includes a static random access memory and the capacitor ladder network includes a C-2C capacitor ladder network.

Example 7 includes a semiconductor apparatus comprising one or more substrates, and logic coupled to the one or more substrates, wherein the logic is implemented at least partly in one or more of configurable or fixed-functionality hardware, the logic including a memory array to store multibit weight data, and a capacitor ladder network to conduct multiply-accumulate (MAC) operations on first analog signals and the multibit weight data, the capacitor ladder network further to output second analog signals based on the MAC operations, wherein the capacitor ladder network is external to the memory array.

Example 8 includes the semiconductor apparatus of Example 7, wherein the capacitor ladder network includes a plurality of switches and the logic includes a controller to selectively activate the plurality of switches based on a data format of the multibit weight data.

Example 9 includes the semiconductor apparatus of Example 8, wherein the plurality of switches includes a plurality of switch pairs, and wherein each switch pair corresponds to one of the second analog signals.

Example 10 includes the semiconductor apparatus of Example 8, wherein the data format includes one of an eight-bit integer format or a four-bit integer format.

Example 11 includes the semiconductor apparatus of Example 7, wherein the capacitor ladder network includes a plurality of partial output activation lines to carry the second analog signals, and one or more multiplexers coupled to the plurality of partial output activation lines, the one or more multiplexers to combine the second analog signals.

Example 12 includes the semiconductor apparatus of any one of Examples 7 to 11, wherein the memory array includes a static random access memory.

Example 13 includes the semiconductor apparatus of any one of Examples 7 to 12, wherein the capacitor ladder network includes a C-2C capacitor ladder network.

Example 14 includes the semiconductor apparatus of any one of Examples 7 to 12, wherein the logic coupled to the one or more substrates includes transistor regions that are positioned within the one or more substrates.

Example 15 includes a method of operating a performance-enhanced computing system, the method comprising storing multibit weight data to a memory array, conducting, by a capacitor ladder network, multiply-accumulate (MAC) operations on first analog signals and the multibit weight data, and outputting, by the capacitor ladder network, second analog signals based on the MAC operations, wherein the capacitor ladder network is external to the memory array.

Example 16 includes the method of Example 15, further including selectively activating, by a controller, a plurality of switches in the capacitor ladder network based on a data format of the multibit weight data.

Example 17 includes the method of Example 16, wherein the plurality of switches includes a plurality of switch pairs, and wherein each switch pair corresponds to one of the second analog signals.

Example 18 includes the method of Example 16, wherein the data format includes one of an eight-bit integer format or a four-bit integer format.

Example 19 includes the method of Example 15, further including carrying, by a plurality of partial output activation lines, the second analog signals, and combining, by one or more multiplexers coupled to the plurality of partial output activation lines, the second analog signals.

Example 20 includes the method of any one of Examples 15 to 19, wherein the memory array includes a static random access memory and the capacitor ladder network includes a C-2C capacitor ladder network.

Example 21 includes an apparatus comprising means for performing the method of any one of Examples 15 to 20.

Analog in-memory computing technology described herein therefore provides superior performance advantages as opposed to other in-memory computing solutions. For example, the technology described herein provides edge AI platforms with both high throughput and high efficiency. Embodiments address two major technical problems associated with analog CiM-analog MAC computation circuit overhead and lack of reconfigurability on data format. With these challenges alleviated, a potential analog CiM accelerator based on the technology described herein can significantly outperform conventional offerings (e.g., reconfigurable weight data formats during inference when switching between layers of a neural network). The resulting performance advantages are particularly beneficial in edge AI applications in which computing throughput and memory density are issues of concern. The technology described herein also obviates any need to under-utilize existing multibit weight data formats or have only single-bit weight data format in analog CiM arrays (e.g., combined with performing bit-serial operation digitally outside CiM arrays) in an effort to achieve reconfigurable weight data formats in analog CiM.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller; and
a processor coupled to the network controller, the processor including logic coupled to one or more substrates, wherein the logic includes:
a memory array to store multibit weight data; and
a capacitor ladder network to conduct multiply-accumulate (MAC) operations on first analog signals and the multibit weight data, the capacitor ladder network further to output second analog signals based on the MAC operations, wherein the capacitor ladder network is external to the memory array.

2. The computing system of claim 1, wherein the capacitor ladder network includes a plurality of switches and the logic includes a controller to selectively activate the plurality of switches based on a data format of the multibit weight data.

3. The computing system of claim 2, wherein the plurality of switches includes a plurality of switch pairs, and wherein each switch pair corresponds to one of the second analog signals.

4. The computing system of claim 2, wherein the data format includes one of an eight-bit integer format or a four-bit integer format.

5. The computing system of claim 1, wherein the capacitor ladder network includes:
a plurality of partial output activation lines to carry the second analog signals; and
one or more multiplexers coupled to the plurality of partial output activation lines, the one or more multiplexers to combine the second analog signals.

6. The computing system of claim 1, wherein the memory array includes a static random access memory and the capacitor ladder network includes a C-2C capacitor ladder network.

7. A semiconductor apparatus comprising:
one or more substrates; and
logic coupled to the one or more substrates, wherein the logic is implemented at least partly in one or more of configurable or fixed-functionality hardware, the logic including:
a memory array to store multibit weight data; and
a capacitor ladder network to conduct multiply-accumulate (MAC) operations on first analog signals and the multibit weight data, the capacitor ladder network further to output second analog signals based on the MAC operations, wherein the capacitor ladder network is external to the memory array.

8. The semiconductor apparatus of claim 7, wherein the capacitor ladder network includes a plurality of switches and the logic includes a controller to selectively activate the plurality of switches based on a data format of the multibit weight data.

9. The semiconductor apparatus of claim 8, wherein the plurality of switches includes a plurality of switch pairs, and wherein each switch pair corresponds to one of the second analog signals.

10. The semiconductor apparatus of claim 8, wherein the data format includes one of an eight-bit integer format or a four-bit integer format.

11. The semiconductor apparatus of claim 7, wherein the capacitor ladder network includes:
a plurality of partial output activation lines to carry the second analog signals; and
one or more multiplexers coupled to the plurality of partial output activation lines, the one or more multiplexers to combine the second analog signals.

12. The semiconductor apparatus of claim 7, wherein the memory array includes a static random access memory.

13. The semiconductor apparatus of claim 7, wherein the capacitor ladder network includes a C-2C capacitor ladder network.

14. The semiconductor apparatus of claim 7, wherein the logic coupled to the one or more substrates includes transistor regions that are positioned within the one or more substrates.

15. A method comprising:
storing multibit weight data to a memory array;
conducting, by a capacitor ladder network, multiply-accumulate (MAC) operations on first analog signals and the multibit weight data; and
outputting, by the capacitor ladder network, second analog signals based on the MAC operations, wherein the capacitor ladder network is external to the memory array.

16. The method of claim 15, further including selectively activating, by a controller, a plurality of switches in the capacitor ladder network based on a data format of the multibit weight data.

17. The method of claim 16, wherein the plurality of switches includes a plurality of switch pairs, and wherein each switch pair corresponds to one of the second analog signals.

18. The method of claim 16, wherein the data format includes one of an eight-bit integer format or a four-bit integer format.

19. The method of claim 15, further including:
carrying, by a plurality of partial output activation lines, the second analog signals; and
combining, by one or more multiplexers coupled to the plurality of partial output activation lines, the second analog signals.

20. The method of claim 15, wherein the memory array includes a static random access memory and the capacitor ladder network includes a C-2C capacitor ladder network.
